(19) United States
(12) Patent Application Publication
(10) Pub. No.: US 2005/0204879 A1
(43) Pub. Date: Sep. 22, 2005

(54) Automated boring bar

(76) Inventors: Horst W. Kwech, Lake Villa, IL (US); Steven R. Larson, Palatine, IL (US)

Correspondence Address: SUMMA & ALLAN, P.A., 11610 NORTH COMMUNITY HOUSE ROAD, SUITE 200, CHARLOTTE, NC, 28277, US

(21) Appl. No.: 10/805,879

(22) Filed: Mar. 22, 2004

(51) Int. Cl. B23B 41/00

(52) U.S. Cl. 82/1.2

(57) ABSTRACT

The present invention relates to an improved apparatus and method for machining pipe. In one aspect, the multifunction apparatus is an improved device for machining the inside diameter and outside diameter of pipe, as well as shaping the wall of pipe. In another aspect, the invention is an improved method for machining pipe. In particular, the method employs a one-to-one communication ratio between the geared components that control the position of the cutting tool in order to eliminate rounding errors associated with conventional gearing systems.

### FIELD OF THE INVENTION

The present invention relates to an automated multifunction tool for machining a metal cylinder. The invention particularly relates to a portable, remotely controlled, multifunction tool that can be positioned inside a pipe to perform precision machining operations. Such operations include, but are not limited to, machining the inside and outside diameters of pipes, as well as facing and transitioning pipe walls.

### BACKGROUND OF THE INVENTION

Devices for machining pipes or other hollow cylindrical objects are well known. Many such devices include a peripherally mounted, radially adjustable cutting tool. The devices are typically powered by a motor, but may be driven manually as well. The devices are used, for example, to bore, contour, thread, and smooth pipe, valves, and couplings.

One outstanding example is U.S. Pat. No. 4,411,178 to Wachs, which is incorporated entirely herein by reference. Although the Wachs '178 patent discloses a device that provides excellent mechanical reliability, it is specific to the preparation of pipe ends.

Another superior example is U.S. Pat. No. 4,758,121 to Kwech, which is also incorporated entirely herein by reference. The Kwech '121 patent discloses a device that provides advantageous portability, yet that is specific to internal machining of pipe.

Yet another excellent example is U.S. Pat. No. 5,429,456 to Kwech, also incorporated entirely herein by reference. The Kwech '456 patent discloses an excellent device for the automatic machining and facing of gate valves, but is specific for this purpose.

Unfortunately, prior devices fail to accurately track the position of the cutting tool during machining operations. For example, if the radial adjustment mechanism includes a pneumatic system with compressible fluid, the exact position of the cutting head becomes unknown after any adjustment.

In addition, earlier technology in this field incorporated the use of planetary gears. As will be known to persons having ordinary skill in the art, planetary gears are prone to “backlash,” also referred to as “gear lash.” These terms refer to the distance through which one part of connected machinery can be moved without moving the connected parts, resulting from looseness in fitting or from wear. See Merriam-Webster's Revised Unabridged Dictionary. Alternatively, backlash refers to the jarring or reflex motion caused in badly fitting machinery by irregularities in velocity or reverses of motion. Such slack in the planetary gears introduces uncertainty as to whether proper adjustment has been made to compensate for tool wear or to adjust for non-uniformity in the cylinder wall. These limitations are compounded in field applications, causing irregular and out-of-round finish, over-machining or under-machining, and increased demands upon operators.

In certain applications, such as machining pipe in an environment dangerous to humans or precision machining for the purpose of fitting and welding pipe, there is a need for exact knowledge of the tool head placement. Such capability would limit the exposure of field workers to hostile conditions. Furthermore, such knowledge would save time and resources in that the pipe is mated precisely and welded completely. This would help to avoid the problem of patching, cutting, grinding, and re-welding a malformed pipe joint.

### SUMMARY OF THE INVENTION

The invention relates to an automated multifunction apparatus that machines pipe. The apparatus can be controlled by a computer and will mount within the internal diameter of a pipe. The apparatus further includes the capability of communicating the axial and radial position of the cutting tool to the computer while the computer controls the axial and radial movement of the tool.

Adjusting the position of the cutting tool is achieved via a one-to-one ratio between a servomotor output shaft and a cutting tool adjustment shaft. In other words, one rotation of the servomotor output shaft equals one rotation of the cutting tool adjustment shaft. This eliminates inaccuracies associated with backlash and rounding errors from fractional gear ratios.

One feature of the present invention is to provide an automated multifunction tool for machining pipe in a radioactive (or otherwise hostile) environment via remote computer control. Additionally, in non-hostile environs, the ease of operation of the computer control system compared to a non-automated control system will lessen the dependence upon highly trained machinists.

Another feature of the present invention is to provide an automated multifunction tool for machining the interior of pipe following an automatic or manual setup procedure.

Yet another feature of the present invention is to provide an automated multifunction tool for machining the end of a pipe for joining through such means as welding, for example. Preparing the end of a pipe includes such functions as facing, beveling, and transitioning, for example.

Still another feature of the present invention is to provide an automated multifunction tool for preparing the outside diameter of the pipe. Such preparation techniques include functions such as beveling, chamfering, and angling, for example.

In carrying out these features, it is an object of the present invention to provide an automated multifunction tool under electronic computer control. The multifunction tool is mountable inside the diameter of a pipe. The multifunction tool includes a chuck body in physical communication with a main rotating frame via a mast. The mast is centrally mounted on the chuck body and feeds through the main rotating frame. The main rotating frame rotates about an axis coincident with the axis of the pipe.

A radially adjustable tool holder is mounted on the main rotating frame such to allow a tool mounted therein to engage and disengage the pipe. The tool holder is connected to a tool slide that is in geared communication with the output shaft of a servomotor. One rotation of the output shaft of the servomotor equals one rotation of the cutting tool adjustment shaft. This one-to-one relationship between the gearing eliminates rounding errors associated with using different sized gears and thus is more accurate. No calculations or compensations need to be made for the rounding. The position of the tool is further monitored and adjusted by encoders and servomotors in electrical communication with and controlled by a computer.

Movement along the axis of the mast (i.e., axial movement) is accomplished by a mast feed screw housed inside the mast. The mast feed screw threads through a mast feed nut mounted on the stationary housing. Axial movement is powered by servomotors, encoders, and miter gearing in electrical communication with and controlled by a computer.

The rotary support typically receives power from a hydraulic pump. The power will distribute through a hydraulic motor and gearing output to turn the rotary support. The hydraulic motors and gearing output is housed in the non-rotary housing mounted on the mast.

Automation of this process is greatly aided by the use of slip rings. As will be known to those of ordinary skill in the art, slip rings are used in electric rotating machinery and provide continuous electrical connection between rotating and stationary conductors. See e.g., Scientific and Technical Terms (5^{th} ed. 2003).

### BRIEF DESCRIPTION OF THE DRAWINGS

FIG. 1 is a perspective side view of a multifunction apparatus to machine cylindrical objects.

FIG. 2 is a perspective end view of a multifunction apparatus to machine cylindrical objects.

FIG. 3 is an enlarged perspective view of the shaft of the multifunction apparatus.

FIG. 4 is a frontal perspective view of the rotary housing.

FIG. 4a is a cross-sectional side view of the rotary and non-rotary housing showing the shaft axis, drive motor, gearbox, tool holder, and cutting tool.

FIG. 5 is an enlarged cross-sectional side view of the gearbox.

FIG. 6 is a schematic depicting a method of computer control for machining a cylindrical object.

### DETAILED DESCRIPTION OF THE INVENTION

The present invention relates to an improved apparatus and method for machining pipe.

In one aspect, the multifunction apparatus is an improved device for machining the inside diameter and outside diameter of pipe, as well as shaping the wall of pipe.

In another aspect, the invention is an improved method for machining pipe. In particular, the method employs a one-to-one communication ratio between the geared components that control the position of the cutting tool. This eliminates rounding errors associated with conventional gearing systems.

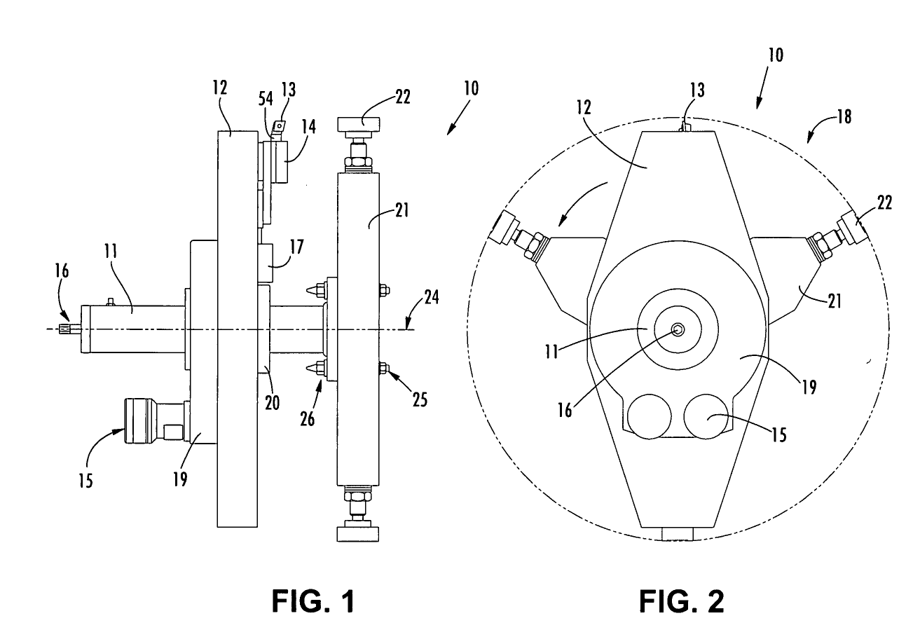

Referring to FIGS. 1 and 2, a multifunction apparatus 10 for machining cylindrical objects 18 (e.g., pipe) in situ is disclosed.

FIGS. 1 and 2 illustrate a shaft 11 (e.g., mast) about which a rotary support 12 (or rotary housing) is coupled. The coupling of the rotary support 12 to the mast 11 allows for rotation of the rotary support 12 around the mast 11. Positioned on the rotary support 12 is a tool holder 14 having at least one cutting tool 13. Mounted adjacent to the rotary support 12 and about the shaft 11 is the non-rotary housing 19. In a typical embodiment, the non-rotary housing 19 contains a drive motor 15 for rotating the rotary support 12, and thus the cutting tool 13, around the shaft 11. This is denoted in FIG. 2 by the counterclockwise arrow.

It will be understood by those of ordinary skill in the art that the drive motor 15 may be, for example, hydraulic, electric, or pneumatic. Typically, however, the drive motor 15 is a hydraulic motor in geared communication with the rotary support 12 and in fluid communication with a hydraulic pump (not shown).

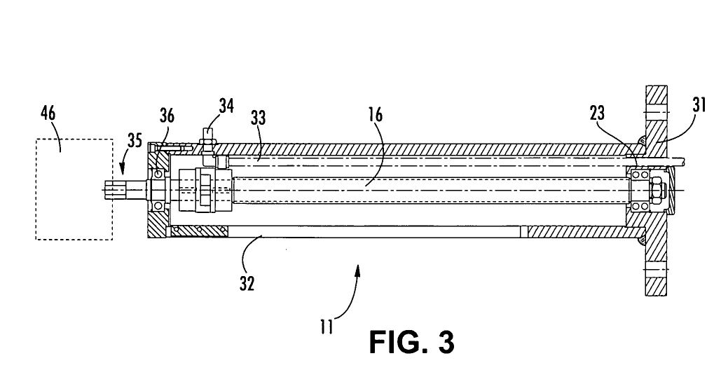

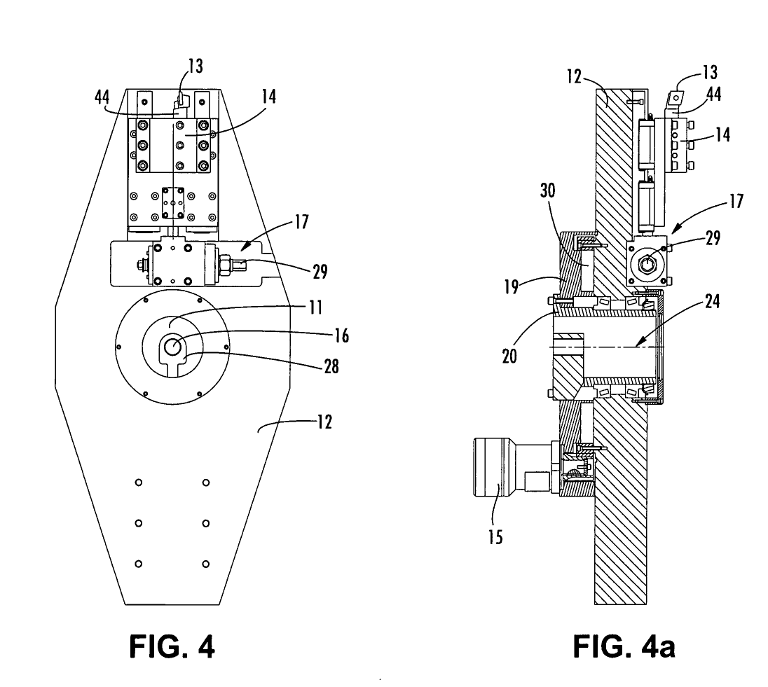

FIGS. 1 and 3 depict a mast feed screw 16. The mast feed screw 16 is a threaded member mounted on a plurality of roller bearings 23 within the shaft 11. The mast feed screw 16 is further in threaded communication with a mast feed nut 28 (see FIG. 4) mounted within the non-rotary housing 19. Axial adjustment of the rotary support 12 along the shaft axis 24 (i.e., the central axis) is accomplished when the mast feed nut 28 travels along the rotating mast feed screw 16.

Axial adjustment is driven by a mast feed screw servomotor 46 (FIG. 3) in geared communication with the mast feed screw 16. The mast feed screw servomotor 46 turns the mast feed screw 16 through a physical connection at the first end 35 (i.e., rotative input). Accordingly, the mast feed screw 16 rotates. Referring to FIGS. 1 and 4, the rotary support 12 and the non-rotary housing 19 move along the shaft axis 24 via the mast feed nut 28. The mast feed nut 28 is held stationary within the non-rotary housing 19, permitting axial adjustment of the non-rotary housing 19 and the rotary support 12. In other words, the mast feed nut 28 threads the length of the mast feed screw 16 upon rotative input from the mast feed screw servomotor 46 (FIG. 3). Since the mast feed nut 28 is held stationary in the non-rotary housing 19, and the rotary support 12 is coupled to the non-rotary housing 19, both the non-rotary housing 19 and the rotary support 12 move with the mast feed nut 28.

It will be understood by those of ordinary skill in the art that the axial adjustment may be powered, for example, by a hydraulic, electric, or pneumatic motor. Other kinds of power systems are within the knowledge of persons having ordinary skill in the art. Moreover, the servomotors herein described are available from various manufacturers, such as Maxon Motor AG (Madison, Wis., USA).

In a typical embodiment, axial adjustment includes an electric mast feed screw servomotor 46 commanded by a controller, such as a computer 45. It will be further understood by those of ordinary skill in the art that a controller may run a program or respond to real-time operator input.

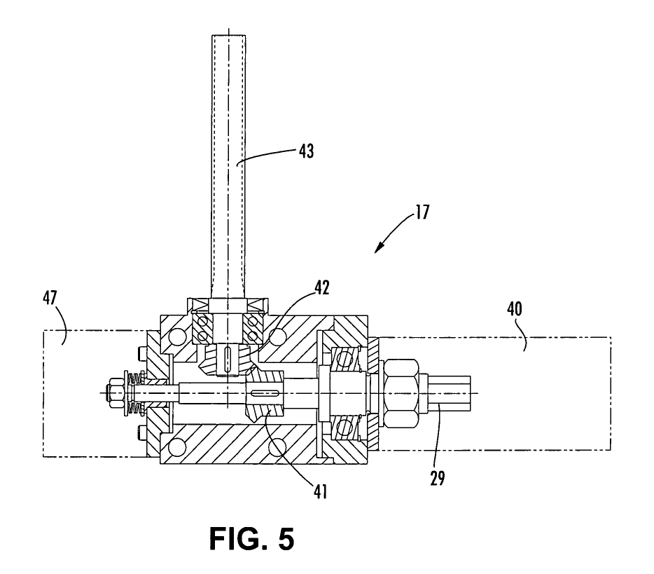

Generally illustrated in FIGS. 4 and 4a, and specifically illustrated in FIG. 5, is a gearbox 17. The gearbox 17 changes the radial distance of the cutting tool 13 with respect to the shaft axis 24. The gearbox 17 is driven by a tool slide servomotor 40 in geared communication with a cutting tool adjustment shaft 43. In other words, the tool slide servomotor 40 is a gearbox servomotor 40.

Specifically shown in FIG. 5, the gearbox 17 is fed by a gearbox servomotor 40 having an output shaft (not shown). The output shaft (not shown) communicates in a one-to-one ratio with the radial adjustment input shaft 29 and the cutting tool adjustment shaft 43. Rotation of the radial adjustment input shaft 29 turns a first spiral miter gear 41 that is in geared communication with a second spiral miter gear 42. The first spiral miter gear 41 is further oriented at about a 90° angle to the second spiral miter gear 42. The second spiral miter gear 42 is connected to the cutting tool adjustment shaft 43 and turns upon rotation of the radial adjustment input shaft 29.

Referring to FIGS. 4 and 5, the cutting tool adjustment shaft 43 is threadably engaged to the tool slide 44 via a nut (not shown) fixed to the tool slide 44. Accordingly, the tool slide 44 and cutting tool 13 move radially relative to the mast 11 upon rotation of the radial adjustment input shaft 29 and the cutting tool adjustment shaft 43.

As previously discussed, the tool slide servomotor 40 may be powered, for example, via a hydraulic, electric, or pneumatic motor. In a preferred embodiment, the gearbox 17 employs an electric gearbox servomotor 40 commanded by the same computer 45 controlling the mast feed screw 16.

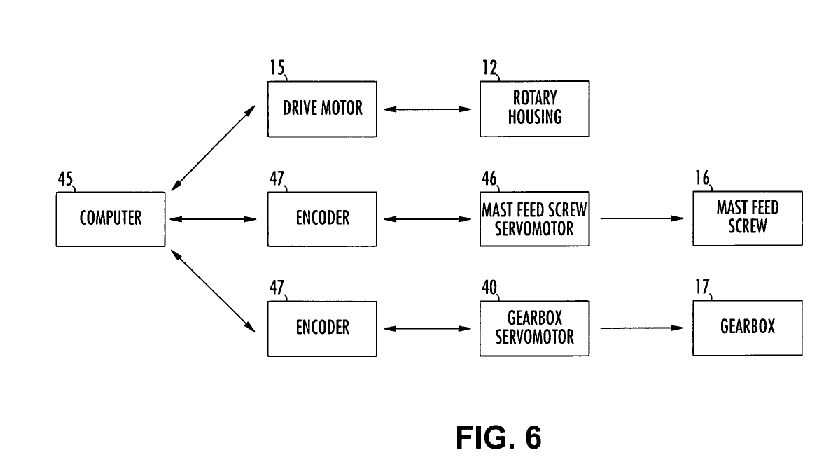

In an especially preferred embodiment illustrated in FIG. 6, the mast feed screw 16 and the gearbox 17 are controlled simultaneously by a computer 45. The computer 45 executes the commands of a computer program or the commands of an operator in real-time. The computer 45 further receives signals from the servomotors 40, 46 and encoders 47 such that the axial and radial position of the cutting tool 13 is known.

In another aspect, the invention is a multifunction apparatus 10 useful for the in-situ machining of pipe 18. Referring to FIGS. 1-3, the apparatus 10 includes a mast 11 having a mounting surface 31 for securing to a chuck body 21, preferably using a plurality of bolts 25 and nuts 26. The chuck body 21 further includes adjustable chuck feet 22 for securing the apparatus 10 within a pipe 18. The chuck body 21 may further include a self-centering mechanism (not shown) to ensure that the apparatus 10 is mounted within a pipe 18 by the chuck body 21 such that the mast 11 is substantially coaxial with the pipe 18.

The mast 11, which surrounds the mast feed screw 16, further includes at least one slotted aperture 32. The slotted aperture 32 allows access for the non-rotary housing 19 to engage the mast feed screw 16, specifically engaging at the mast feed nut 28. This permits axial adjustment of the rotary support 12 and non-rotary housing 19. The slotted aperture 32 also defines the limit of axial adjustment.

The mast 11 may also include a hose 33 having a hose fitting 34 for liquid transport to the cutting tool 13. The purpose of the liquid is to lubricate, cool, and wash metal shavings away from the cutting tool 13 during the machining process. Suitable liquids are known to those having ordinary skill in the art and include water-miscible oils, such as CLEAR-CUT or LUBRI-FLO oils produced by Larson Chemical Company of Greendale, Wis., USA.

Referring to FIGS. 2 and 4, the multifunction apparatus 10 as described will have an adjustable tool mechanism or tool holder 14 affixed at the rotary support 12. The tool holder 14 is positioned to place a cutting tool 13 on a surface of the pipe 18. As illustrated in FIGS. 4 and 5, the tool holder 14 will receive input from a cutting tool adjustment shaft 43, which is threadably engaged to the tool slide 44 via a nut (not shown). Accordingly, the tool holder 14 and cutting tool 13 will adjust in a radial direction upon input from the gearbox servomotor 40. Specifically, the gearbox servomotor output shaft (not shown) turns the radial adjustment input shaft 29, the first spiral miter gear 41, the second spiral miter gear 42, and the cutting tool adjustment shaft 43 to move the tool holder 14 and the cutting tool 13.

In another typical embodiment illustrated in FIG. 6, a computer 45 communicates with and controls the mast feed screw servomotor 46 and the gearbox servomotor 40. The drive motor 15, which powers angular movement, may also be computer controlled, but is typically controlled separately via hydraulic power. The computer 45 transmits signals to and receives signals from the servomotors 40, 46. These signals describe the axial and radial position of the rotary support 12 and the cutting tool 13, respectively.

Depicted in FIGS. 4a and 6, communication between the computer 45 and each servomotor 40, 46 is facilitated by the use of electrical components well known to those of ordinary skill in the art. From the computer 45, signals travel through wiring (not shown) to fixed brushes (not shown) in contact with a slip ring 30 mounted on the non-rotary housing 19. The signals then travel to spring brushes (not shown) in the rotary support 12, and then to an encoder 47, and then to the respective servomotor 40, 46. Conversely, signals return to the computer 45 in reverse order from the servomotor 40, 46 and encoder 47. The computer 45 interprets the signals to simultaneously determine the axial and radial position of the cutting tool 13.

The signals transmitted between the gearbox 40 and the computer 45 convey a one-to-one communication ratio between the components that control the position of the cutting tool 13. Specifically, these components are the gearbox servomotor output shaft (not shown), the radial adjustment input shaft 29, and the cutting tool adjustment shaft 43.

In other words, one rotation of the gearbox servomotor output shaft (not shown) translates to one rotation of the cutting tool adjustment shaft 43. The primary advantage of this system is that no correction for fractional rounding is necessary between the two shafts. Thus, the position of the cutting tool 13 is known after any adjustment.

The computer 45 can also determine the spatial positioning of the cutting tool 13. For example, the computer 45 can track the angular orientation (θ coordinate position) of the cutting tool 13. The θ coordinate position is typically determined relative to a zero position established in the pipe 18.

Referring to FIG. 4a, the multifunction apparatus 10 further includes a slideable sleeve member 20 mounted between the mast 11, the rotary support 12, and the non-rotary housing 19. The slideable sleeve member 20 allows the rotary support 12 and the non-rotary housing 19 to move along the shaft axis 24. The slideable sleeve member 20 also allows the rotary support 12 to rotate about the mast 11 without having to turn the mast 11.

The cutting tool 13 is constructed of a suitable material for cutting and machining steel pipe 18, including, but not limited to, hardened steel and hardened steel alloys, carbide-tipped and carbide-coated steel. Other suitable materials are known to persons having ordinary skill in the art.

In another aspect, the invention is a method for machining pipe 18. Referring to FIGS. 1, 2, and 4a, the method includes positioning the cutting tool 13 within a substantially cylindrical pipe 18. The positioning step may be performed manually by an operator or remotely using a self-centering mechanism. Self-centering mechanisms, which are known to persons having ordinary skill in the art may be controlled, for example, by electric, hydraulic, or pneumatic motors.

To facilitate proper positioning of the cutting tool 13, the method further includes rotating the cutting tool 13 around the shaft axis 24 and radial adjustment of the cutting tool 13. Setting the initial radial position of the cutting tool 13 in this way is known to those of ordinary skill in the art as “touching off” the pipe 18. Specifically, touching off the pipe 18 includes radial extension of the cutting tool 13 to within about 0.010 inch of the pipe 18 and slowly rotating the cutting tool 13 about the shaft axis 24. This step determines whether the multifunction apparatus 10 is placed in the center of the pipe 18, or close enough to the center of the pipe 18 to provide effective machining. In other words, this step determines the concentricity between the apparatus and the pipe 18.

Once concentricity is established, the roundness of the pipe 18 itself is evaluated. It will be understood by those of ordinary skill in the art that “substantially cylindrical” includes not only circular pipe, but also pipe that is slightly out of round, whether by design or physical damage to the pipe.

The method of the invention further includes defining (i.e., setting) an origin point. The origin point may be established, for example, by the operator or by a computer 45. Typically, the origin point is defined as the initial zero position. The origin point not only describes the aforementioned initial radial position of the cutting tool 13 with respect to the pipe 18, but also describes the initial axial position of the cutting tool 13.

In this regard, defining the axial position of the cutting tool 13 includes a manual or computer measurement of the location of the cutting tool 13 relative to the length of the mast 11. More specifically, this measurement is relative to the slotted aperture 32 (FIG. 3) that defines the axial range of the cutting tool 13.

Defining the origin point may further include defining the initial angular orientation of the cutting tool 13 with respect to the shaft axis 24. The origin point, which may be established, for example, by the operator or by a computer 45, is typically defined as zero degrees on a coordinate system of 0-360 degrees.

Those having ordinary skill in the art will appreciate that the origin point may be defined by various coordinate systems, particularly rectangular or cylindrical coordinate systems.

Following the establishment of the origin point, the cutting tool 13 is rotated around the shaft axis 24 while the cutting tool 13 is engaging the pipe 18, thereby machining the pipe 18.

The computer 45 simultaneously controls the axial and radial positioning and movement of the cutting tool 13 while the apparatus machines the pipe 18. Computer 45 adjustment of the axial and radial positions of the cutting tool 13 is accomplished by electronically signaling the appropriate servomotor 40, 46 to adjust the axial or radial position using the gearbox 17 or mast feed screw 16, respectively. The signal may originate from an operator, a computer program, or both (e.g., a computer program that prompts an operator for input). In the preferred embodiment of the method, the computer 45 controls and adjusts the axial and radial positioning simultaneously.

In addition to simultaneously controlling and adjusting the axial and radial position of the cutting tool 13, the computer 45 may also monitor and report the angular position of the cutting tool 13 relative to the shaft axis 24. For example, an infrared or laser light can be mounted about the rotary support 12 and project onto the interior of the pipe 18 to provide a point of reference for the angular position.

The method for machining pipe 18 further facilitates the machining of the interior diameter, outside diameter, and the end of the pipe 18. This is accomplished with the use of a properly shaped or angled cutting tool 13 known to those of ordinary skill in the art. For example, a pointed cutting tool is used to machine the inside diameter of the pipe 18, whereas an angled or curved cutting tool is used to machine the outside diameter, or to shape the wall of the pipe 18 to facilitate fitting and welding.

While typical and preferred embodiments of the invention have been described in detail, it will be appreciated by those of ordinary skill in the art that various modifications can be developed based on the teachings of this disclosure. Accordingly, the embodiments disclosed are meant for illustrative purposes only and are not intended to limit the scope of invention. The scope of the invention is to be given the full breadth of the following claims.

1. A multi-function apparatus for machining cylindrical objects, comprising:
a shaft;
a rotary support rotatably coupled to said shaft;
a cutting tool positioned in a tool holder at said rotary support;
means for rotating said rotary support and said cutting tool around said shaft;
axial adjustment means for changing the axial position of said cutting tool with respect to said shaft;
radial adjustment means for changing the radial distance of said cutting tool with respect to said shaft, said radial adjustment means comprising a tool slide servomotor in one-to-one communication with an adjustable tool mechanism; and
a controller, said controller regulating said axial adjustment means and said radial adjustment means.

2. An apparatus as in claim 1, wherein said means for rotating said rotary support comprises a motor in geared communication with said rotary support.

3. An apparatus as in claim 2, wherein said motor is hydraulically powered.

4. An apparatus as in claim 2, wherein said motor is electrically powered.

5. An apparatus as in claim 1, wherein said axial adjustment means comprises a mast feed screw servomotor in geared communication with a mast feed screw.

6. An apparatus as in claim 1, wherein said tool slide servomotor in one-to-one communication with an adjustable tool mechanism comprises a gearbox servomotor output shaft in one-to-one geared communication with a cutting tool adjustment shaft.

7. An apparatus as in claim 1, wherein said controller is a computer.

8. An apparatus as in claim 7, wherein said computer simultaneously controls the axial and radial position of said cutting tool.

9. An apparatus as in claim 7, wherein said computer controls, via programmed instructions, the movement of said axial adjustment means and said radial adjustment means.

10. A multi-function apparatus that is useful for the machining of pipe, comprising:
a mast, said mast comprising an internal mast feed screw;
a mast feed screw servomotor for turning said mast feed screw;
a non-rotary housing coupled to said mast, said non-rotary housing moveable along said mast;
a rotary housing positioned adjacent to said non-rotary housing and rotatably coupled to said mast, said rotary housing moveable along said mast;
means for rotating said rotary housing about said mast;
an adjustable tool mechanism affixed at said rotary housing, said adjustable tool mechanism comprising a cutting tool and a cutting tool adjustment shaft;
a gearbox servomotor having an output shaft, said gearbox servomotor output shaft in one-to-one geared communication with said cutting tool adjustment shaft to adjust the radial position of said cutting tool relative to said mast; and
a computer in communication with said mast feed screw servomotor and said gearbox servomotor;
wherein said computer transmits signals to and receives signals from said mast feed screw servomotor with respect to the axial position of said adjustable tool mechanism; and
wherein said computer transmits signals to and receives signals from said gearbox servomotor with respect to the radial position of said adjustable tool mechanism.

11. An apparatus as in claim 10, wherein said mast defines a slotted aperture that limits the axial range of said rotary housing.

12. An apparatus as in claim 10, wherein a mast feed nut is threadably engaged to said mast feed screw, said mast feed nut mounted to said non-rotary housing.

13. An apparatus as in claim 10, wherein said rotating means comprises a motor at said non-rotary housing, said motor engaging said rotary housing to thereby rotate said rotary housing about said mast.

14. An apparatus as in claim 10, wherein the mast feed screw servomotor is hydraulically powered.

15. An apparatus as in claim 10, wherein the mast feed screw servomotor is electrically powered.

16. An apparatus as in claim 10, wherein the gearbox servomotor is hydraulically powered.

17. An apparatus as in claim 10, wherein the gearbox servomotor is electrically powered.

18. An apparatus as in claim 10, further comprising a slideable sleeve member, said slideable sleeve member positioned about said mast and affixed to said rotary housing, wherein said slideable sleeve member allows rotation of the rotary housing about said mast.

19. An apparatus as in claim 10, further comprising a slideable sleeve member, said slideable sleeve member positioned about said mast and affixed to said rotary housing, wherein said slideable sleeve member allows movement of the rotary housing along said mast.

20. An apparatus as in claim 10, further comprising a chuck body mounted for securing the apparatus within a pipe, said chuck body mounted substantially perpendicular to said mast.

21. An apparatus as in claim 20, wherein said apparatus is mounted within a pipe by said chuck body such that said mast is substantially coaxial with the pipe.

22. An apparatus as in claim 20, wherein said chuck body further comprises a self-centering means.

23. The apparatus as in claim 22, wherein said self-centering means comprises an electronically controlled self-centering mechanism.

24. The apparatus as in claim 22, wherein said self-centering means comprises a hydraulically controlled self-centering mechanism.

25. The apparatus as in claim 22, wherein said self-centering means comprises a pneumatically controlled self-centering mechanism.

26. A method for machining pipe, comprising the steps of:
(a) positioning a cutting tool within a substantially cylindrical pipe, the pipe defining a central axis;
(b) defining an origin point that describes the initial axial position and the initial radial position of the cutting tool with respect to the pipe;
(c) rotating the cutting tool around the central axis while the cutting tool engages the pipe, thereby machining the pipe;
(d) controlling the axial position of the cutting tool; and
(e) controlling the radial position of the cutting tool;
wherein steps (d) and (e) are performed simultaneously under computer control.

27. The method as in claim 26, wherein the step of positioning a cutting tool further comprises rotating the cutting tool around the central axis and touching off the pipe.

28. The method as in claim 26, wherein the step of defining an origin point further comprises defining the initial angular orientation of the cutting tool with respect to the central axis.

29. The method as in claim 26, wherein the step of controlling the axial position of the cutting tool comprises adjusting the axial position of the cutting tool.

30. The method as in claim 26, wherein the step of adjusting the axial position of the cutting tool comprises signaling a servomotor to axially adjust the cutting tool.

31. The method as in claim 26, wherein the step of controlling the radial position of the cutting tool comprises adjusting the radial position of the cutting tool.

32. The method as in claim 31, wherein the step of adjusting the radial position of the cutting tool comprises signaling a servomotor to radially adjust the cutting tool.

33. The method as in claim 26, further comprising the step of monitoring the angular orientation of the cutting tool with respect to the central axis.

34. A method as in claim 26, wherein the step of machining the pipe comprises machining the interior diameter of the pipe.

35. A method as in claim 26, wherein the step of machining the pipe comprises machining the outside diameter of the pipe.

36. A method as in claim 26, wherein the step of machining the pipe comprises machining the end of the pipe.
